(19) United States
(12) Patent Application Publication
(10) Pub. No.: US 2026/0143193 A1
(43) Pub. Date: May 21, 2026

(54) SYSTEMS AND METHODS FOR PROVIDING DIGITAL VIDEO RECORDING IN MULTIPLE DWELLING UNITS

(71) Applicant: DISH Network L.L.C., Englewood, CO (US)

(72) Inventors: Ryan Burr Scribner, Erie, CO (US); Aaron William Schwartz, Denver, CO (US); Clark Hurst Pendery, Englewood, CO (US); Jason Anthony Madruga, Castle Rock, CO (US); Joshua David Wade, Castle Rock, CO (US); Vinaya Sri Yerneni, Englewood, CO (US); Christian Barnett, Lone Tree, CO (US); Anushree Sandeep Bagwe, Denver, CO (US); Dalton Hertel, Englewood, CO (US)

(21) Appl. No.: 18/953,701

(22) Filed: Nov. 20, 2024

(51) Int. Cl. H04N 21/45; H04N 21/4147

(52) U.S. Cl. CPC H04N 21/4532; H04N 21/4147

(57) ABSTRACT

A multi-dwelling unit DVR management system is described herein. At a first time, the system may receive an indication that a user is to be temporarily associated with a content receiver and generate a temporary account for the user to use the content receiver based on the indication of the user. At the first time, the system causes the content receiver to use the temporary account. At a second time, the system may receive an indication that data associated with the temporary account is to be cleared and may cause the content receiver to clear the data associated with the temporary account.

### BACKGROUND

Various organizations, such as hotels, motels, hostels, short term rental organizations, or other organizations (collectively “Multiple Dwelling Units” or “MDUs”) provide their patrons access to content receivers, such as digital video recorder (“DVR”) devices. It is with respect to this and other considerations that the embodiments described herein have been made.

### BRIEF SUMMARY

The embodiments disclosed herein improve the technology of content receivers by providing a technical solution that generates a temporary account for a content receiver. The embodiments disclosed herein may generate the temporary account based on an indication of a patron, or “user,” that is to be associated with the content receiver. The embodiments disclosed herein may cause the content receiver to delete, or “clear,” data associated with the temporary account based on an indication that data associated with the temporary account is to be cleared.

In some embodiments, an MDU DVR Account Management System receives an indication of a time at which the user is to depart from, as departed from, etc., a geographic location associated with an organization that is associated with the content receiver. In some such embodiments, the MDU DVR Account Management System may cause the content receiver to clear data associated with the temporary account based on the time at which the user is to depart from the geographic location.

In some embodiments, an MDU DVR Account Management System receives an indication of a time at which the user is to arrive at, has arrived at, etc., a geographic location associated with the organization. In some embodiments, the MDU DVR Account Management System receives the indication of the time at which the user is to arrive at the geographic location from a property management system. In some such embodiments, the MDU DVR Account Management System causes a content receiver to use a content presentation device to display information identifying the user.

In some embodiments, the MDU DVR Account Management System causes a content receiver to perform one or more actions by transmitting one or more commands to the content receiver, such as a command to use a temporary account, a command to clear data associated with the temporary account, a command to use a content presentation device to display data, other commands, or some combination thereof. In some embodiments, a property management system causes the content receiver to perform the one or more actions.

In some embodiments, MDU DVR Account Management System when a content receiver is unable to communicate with a property management system during a selected period of time, the MDU DVR Account Management System may receive a request from the content receiver to clear the data associated with the temporary account based on a detection that the content receiver is unable to communicate with the property management system during the selected period of time.

### BRIEF DESCRIPTION OF THE DRAWINGS

FIG. 1 is a display diagram of an example environment in which an MDU DVR Account Management System may operate, according to various embodiments described herein.

FIG. 2 is a block diagram of an MDU DVR Account Management System, according to various embodiments described herein.

FIG. 3 is a flow diagram of a process for causing a content receiver to use a temporary account, according to various embodiments described herein.

FIG. 4 is a flow diagram of a process for generating a temporary account for a user based on an indication that the user has arrived at a geographic area, according to various embodiments described herein.

FIG. 5 is a flow diagram of a process to delete data used by a content receiver at a determined time, according to various embodiments described herein.

FIG. 6 is a flow diagram of a process to automatically configure a content receiver for a user, according to various embodiments described herein.

### DETAILED DESCRIPTION

Organizations, such as hotels, motels, hostels, short term rental organizations, or other organizations (collectively “Multiple Dwelling Units” or “MDUs”), typically provide users with access to a content receiver, such as a digital video recording (“DVR”) device. Such organizations allow their patrons (or “users”) to log into or otherwise access content receivers to view content via a content presentation device. For example, a user in a hotel room may log into a content receiver included in the hotel room to record television programs and view them at a later time. However, conventional systems that allow a user to log into or otherwise access content receivers do not automatically clear the data associated with the user's account when the user leaves the organization, such as, for example, when they check out of a hotel. Additionally, conventional systems that do allow users to log into content receivers raise privacy concerns for users, since the user's account remains logged in at the content receiver of the organization when the next user uses the content receiver. Conventional systems may allow users to work around this limitation by allowing them to create new accounts for each content receiver, however this requires users to conduct multiple account creation and verification steps, and still does not alleviate privacy concerns for users whose temporary account remains logged into the content receiver when the user leaves the organization.

Furthermore, a user who forgets to log their account out of a content receiver may have their account settings tampered with by future users who use the content receiver. For example, a user who logs into their account on a content receiver in a hotel room and forgets to log out may find that the next user who has access to the hotel room has changed their account settings, deleted recorded content, started recording content that the account owner has no interest in, made purchases on the behalf of the account owner without the owner's permission, or otherwise interacts with the account. Additionally, in the case of content receivers that allow switching between profiles, memory resources included in the content receiver is taken by accounts that should not have remained logged in to the content receiver because the user associated with those accounts no longer has access to the content receiver.

The embodiments disclosed herein improve the technology of content receivers by providing a technical solution that generates a temporary account for a content receiver. The embodiments disclosed herein may generate the temporary account based on an indication of a patron, or “user,” that is to be associated with the content receiver. The embodiments disclosed herein may cause the content receiver to delete, or “clear,” data associated with the temporary account based on an indication that data associated with the temporary account is to be cleared. Thus, the embodiments disclosed herein are able to eliminate cases where a user's account is compromised because it was logged into a content receiver located in a multiple-dwelling unit. Furthermore, the embodiments disclosed herein are able to ensure that content receivers in MDUs do not use memory resources for accounts whose user no longer has access to the content receiver.

Unless the context requires otherwise, throughout the specification and claims which follow, the word “comprise” and variations thereof, such as, “comprises” and “comprising” are to be construed in an open, inclusive sense, for example “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments, and references to “some embodiments,” “other embodiments,” “example embodiments,” “one embodiment,” “an embodiment,” etc., do not preclude the combination of the particular features, structures, or characteristics of any of the embodiments with any of the other embodiments described herein.

Throughout this specification and the claims, references to causing a device, such as a computing device or other device, to perform an action, execute instructions, receive data, transmit data, or be affected in some manner, may be made. One of ordinary skill in the art may recognize that a device may cause a second device to be affected in any of the manners listed above by transmitting instructions to the second device, transmitting data to the second device, transmitting instructions or data to a third device that can communicate with the second device, presenting instructions to a user to affect the second device, take other actions that affect the second device, or some combination thereof. In the embodiments described herein, any one or more of these methods may be used to cause a second device to be affected in some manner.

As used in this specification and the appended claims, the singular forms “a,” “an,” and “the” include plural referents unless the content clearly dictates otherwise. The term “or” is generally employed to include “and/or” unless the content clearly dictates otherwise. The term “and/or” is generally employed to include an inclusive or.

The headings and Abstract of the Disclosure provided herein are for convenience only and do not interpret the scope or meaning of the embodiments.

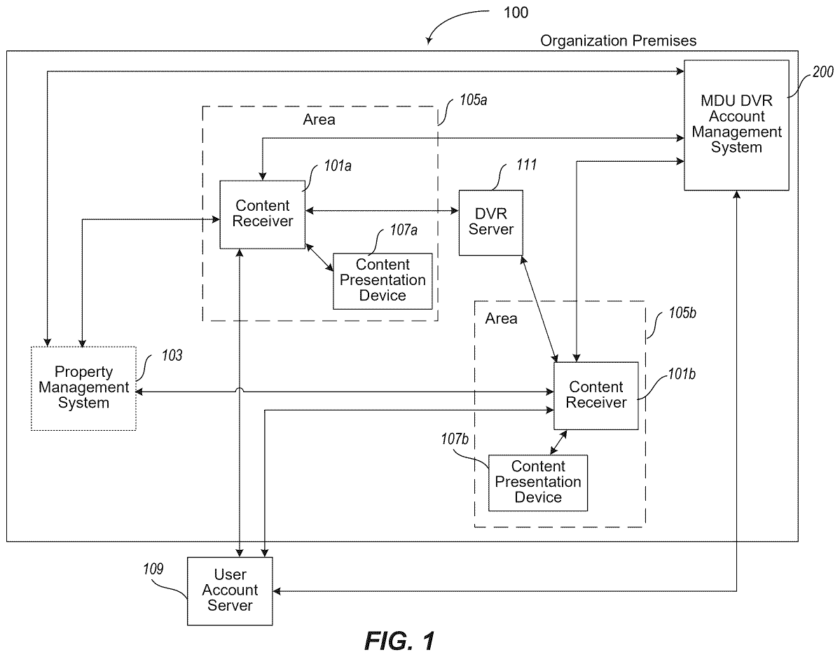

FIG. 1 is a display diagram of an example environment 100 in which an MDU DVR Account Management System may operate, according to various embodiments described herein. The environment 100 may represent a geographic area within which an organization is located, such as the premises of the organization. The environment 100 includes an MDU DVR Account Management System 200 (the “system 200”), one or more content receivers 101a-101b (collectively “content receivers 101” or individually as “content receiver 101”), one or more areas within an organization 105a-105b (collectively as “areas 105” or individually as “area 105”), and one or more content presentation devices 107a-107b (collectively as “content presentation devices 107” or individually as “content presentation device 107”), a user account server 109, and a DVR server 111. In some embodiments, one or more of the areas 105 are rooms within a hotel that a patron of the hotel may check into and stay in for a period of time.

In some embodiments, the environment 100 includes a property management system 103. In such embodiments, the property management system 103 may communicate with one or more content receivers 101, the MDU DVR Account Management System 200, other devices or computer systems, or some combination thereof. The property management system 103 may include data regarding a patron's stay at the organization, the content receivers 101, the areas 105, or some combination thereof. For example, the property management system 103 may include data indicating when a patron is to check in or check out of a hotel. In such an example, the property management system 103 may communicate data regarding the patron to a content receiver that is to be associated with the patron, data regarding when the patron is to be associated with the content receiver, data regarding when the patron is no longer to be associated with the content receiver, other data regarding the patron, or some combination thereof. In some embodiments, the content receiver may be configured to automatically clear a temporary account during a selected time period if the content receiver is unable to communicate with the property management system 103.

The content receivers 101 may be one or more devices that provide content to content presentation devices, such as the content presentation devices 107. For example, a content receiver may be able to obtain television or other content via an internet connection, a broadcast receiver, a satellite receiver, recordings stored within the content receiver, other sources of content, or some combination thereof. A content receiver 101 may be or include: a set-top box, a satellite receiver, a broadcast receiver, a digital video recording device, other devices able to receive content, or some combination thereof. In some embodiments, a content receiver 101 is able to communicate with one or more content providers (not shown) to receive content that is presented to a user via a content presentation device 107.

The user account server 109 may be one or more computer devices, servers, systems, etc., that store user account data associated with one or more user accounts. The user account data may be data for users that already have a user account, temporary user accounts, or other types of user accounts. In some embodiments, content receiver 101 communicates with the user account server 109, such as to verify that a user account indicated by the content receiver 101 exists, to verify a login of a user account to a content receiver 101, to delete user account data associated with a user account, to cause a user account to be created, or some combination thereof.

The DVR server 111 is a computer server that stores DVR data accessible by the content receivers 101. The DVR server 111 may store recorded content, instructions for recording content, other data associated with a DVR, or some combination thereof. The content receivers 101 may communicate with the DVR server 111 to retrieve content on behalf of a user, record content on behalf of a user, or perform other functions associated with a DVR. Data stored on the DVR server may be cleared based on an indication from a content receiver 101, another computing device or system described herein, or some combination thereof, that data associated with a selected user account is to be cleared.

The content receivers 101; property management system 103; content presentation devices 107; user account server 109; DVR server 111; the system 200; other devices; or a combination thereof, may access a wired or wireless network associated with the organization. The network associated with the organization may be a network, communication system, or networked system (not shown), to which the system 200, content presentation devices 107, user account server 109, DVR server 111, content receivers 101, property management system 103, other devices associated with the organization, or some combination thereof may be coupled. Non-limiting examples of such a network or communication system include, but are not limited to, an Ethernet system, twisted pair Ethernet system, an intranet, a local area network (LAN) system, short range wireless network (e.g., Bluetooth®), a personal area network (e.g., a Zigbee network based on the IEEE 802.15.4 specification), a Consumer Electronics Control (CEC) communication system, Wi-Fi, satellite communication systems and networks, cellular networks, cable networks, or the like.

The content presentation devices 107 may be one or more endpoint devices, such as televisions, projectors, PCs, tablets, laptop computers, smartphones, personal assistants, drones, Internet connection devices, vehicles, USB dongles, Mi-Fi devices, wireless LAN, Wi-Fi, Worldwide Interoperability for Microwave Access (WiMax) devices, or the like, and may be communicatively coupled to the network or to each other so that the plurality of endpoint devices are communicatively coupled together. The content presentation devices 107 may be communicatively coupled to a network via interaction with an access point. The content presentation devices 107 may receive content from one or more content receivers 101.

The MDU DVR Account Management System 200 may communicate with the content receivers 101, property management system 103, content presentation devices 107, user account server 109, DVR server 111 (not shown), other computer systems or devices, or some combination thereof. Although FIG. 1 depicts the MDU DVR Account Management System 200 as being included within a geographic area associated with the organization, embodiments are not so limited, and the MDU DVR Account Management System 200, or any of the other devices or systems described in FIG. 1, may communicate with the various devices, systems, receivers, etc., included in the organization premises 100 without being physically present within the organization premises 100, such as by using a wired or wireless network connection to transmit data to and receive data from the various devices, systems, receivers, etc., included in the organization premises 100. The MDU DVR Account Management System 200 may cause a temporary account to be generated for a user that is to be temporarily associated with a content receiver 101 and may cause the temporary account to be logged into the content receiver 101. The user may then use the content receiver via the temporary account until the user is to no longer be associated with the temporary account. In response to detecting that the user is to no longer be associated with the temporary account, the MDU DVR Account Management System 200 may cause data associated with the temporary account to be cleared. In some embodiments, the MDU DVR Account Management System 200 may include a centralized DVR device, DVR server, or some combination thereof, that stores recorded content, such as the DVR server 111. In such embodiments, the content receivers 101 may communicate with the MDU DVR Account Management System 200 to cause content to be recorded, retrieve content, perform other functions related to a DVR, or some combination thereof. In some such embodiments, when data associated with a temporary account is to be cleared, the MDU DVR Account Management System 200 is caused to delete DVR data, such as recorded content, instructions to record content, etc., associated with the temporary account.

In an example embodiment, at least some of the content presentation devices 107 may be television sets located within the rooms of an organization such as a hotel and at least some of the content receivers 101 may be set-top boxes located within the rooms of the hotel. In such an example, a property management system 103, system 200, or some combination thereof, may receive an indication that a user has checked in to the hotel and been assigned a room. The indication may be transmitted to a content receiver 101 associated with the room, and a temporary account is caused to be generated for the content receiver 101, such as by using the user account server 109. Continuing the example, when the property management system 103, system 200, or some combination thereof, detects that the user has checked out of the hotel room, data associated with the temporary account is caused to be deleted by the computing device or system that detects that the user has checked out of the hotel room.

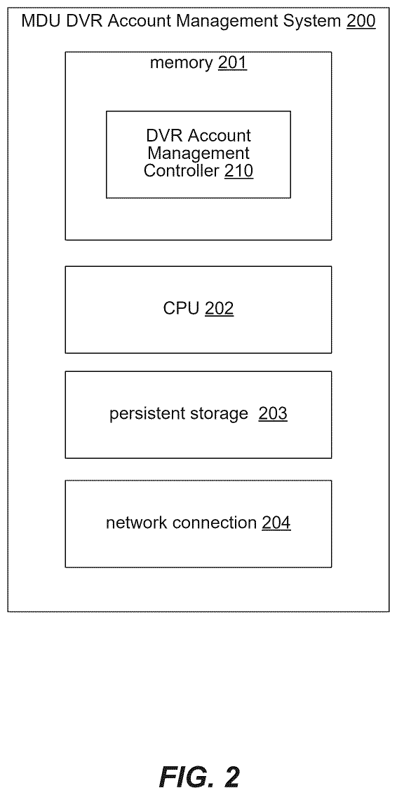

FIG. 2 is a block diagram of an MDU DVR Account Management System 200, according to various embodiments described herein. One or more aspects of the MDU DVR Account Management System 200 may be implemented or integrated on or in a content presentation device (such as a content presentation device 107), content receiver (such as a content receiver 101), property management system (such as a property management system 103), user account server 109, DVR server 111, one or more devices, one or more servers, one or more devices or servers on an organization's premises, or some combination thereof.

In various embodiments, the system 200 includes one or more of the following: a computer memory 201, a processor 202, a persistent storage device 203, and a network connection 204. The memory 201 may be used for storing programs and data while they are being used, including data associated with the system 200, content receivers, content presentation devices, users, other devices, an organization, an operating system including a kernel (not shown), device drivers (not shown), and one or more machine learning models. The processor 202 may be used for executing computer programs (not shown), such as computer programs which perform some or all of the functions of the system 200. In some embodiments, the processor 202 may be one or more processors, microcontrollers, or other computer components. In some embodiments, any of the processors, microcontrollers, or other computer components, either alone or in combination, can perform any of the functions or acts described herein. The persistent storage device 203 may be a hard drive or flash drive for persistently storing programs and data. The network connection 204 may be used for connecting to one or more networks associated with the organization, content receivers, content presentation devices, or other computer systems (not shown), to send or receive data, such as via the Internet or another network and associated networking hardware, such as switches, routers, repeaters, electrical cables and optical fibers, light emitters and receivers, radio transmitters and receivers, and the like, and to scan for and retrieve signals associated with content presentation devices, content receivers, other devices, an MDU DVR Account Management System, and for connecting to one or more computer devices such as content presentation devices, content receivers, an MDU DVR Account Management System, other devices or components associated with an organization associated with the MDU DVR Account Management System, or other computer systems. In various embodiments, the system 200 additionally includes input and output devices, such as a keyboard, a mouse, display devices, etc.

While a system 200 configured as described may be used in some embodiments, in various other embodiments, the system 200 may be implemented using devices of various types and configurations and having various components. The memory 201 may include a DVR Account Management Controller 210, which contains computer-executable instructions that, when executed by the CPU 202, cause the system 200 to perform the operations and functions described herein. For example, the programs referenced above, which may be stored in computer memory 201, may include or be comprised of such computer-executable instructions.

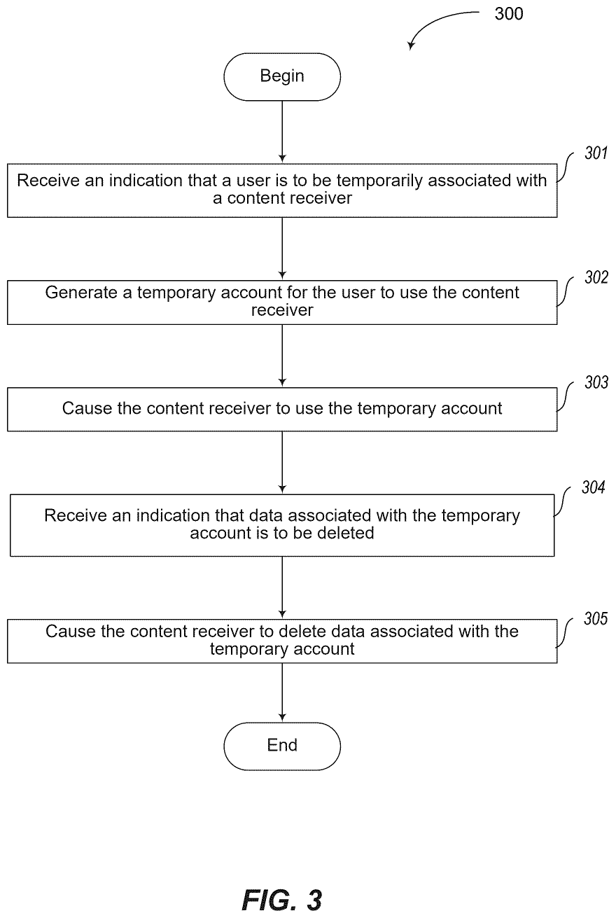

The DVR Account Management Controller 210 (the “controller 210”) performs the core functions of the system 200, as discussed herein and also with respect to FIGS. 3-5. In an example embodiment, the system 200 and the controller 210 are included in a content receiver 101, and the content receiver performs the core functions of the system 200. In particular, the controller 210 detects that a user is to be temporarily associated with a content receiver and generates a temporary account for the user to use the content receiver. Additionally, the controller 210 may receive an indication that data associated with the temporary account is to be deleted and cause the content receiver to delete data associated with the temporary account based on the received indication. In some embodiments, the controller 210 receives the indication that data associated with the temporary account is to be deleted from a property management system 103. In such embodiments, the indication from the property management system 103 may be an indication that the user is to no longer be associated with the content receiver at a selected time, after a selected period of time has elapsed, during a selected period of time, etc. In some embodiments, the controller 210 receives the indication that data associated with the temporary account is to be deleted a part of performing one or more of the processes 300, 400, and 500, described below in connection with FIGS. 3-5. In some embodiments, the controller 210 generates the indication that data associated with the temporary account is to be deleted. In some such embodiments, the controller 210 may generate the indication based on a determination that the content receiver associated with the user is unable to communicate with a property management system, a determination that the system 200 is unable to communicate with a property management system, or some combination thereof.

In an example embodiment, the controller 210 or computer-executable instructions stored on memory 201 of the system 200 are implemented using standard programming techniques. For example, the controller 210 or computer-executable instructions stored on memory 201 of the system 200 may be implemented as a “native” executable running on CPU 202, along with one or more static or dynamic libraries. In other embodiments, the controller 210 or computer-executable instructions stored on memory 201 of the system 200 may be implemented as instructions processed by a virtual machine that executes as some other program.

The embodiments described above may also use synchronous or asynchronous client-server computing techniques. However, the various components may be implemented using more monolithic programming techniques as well, for example, as an executable running on a single processor computer system, or alternatively decomposed using a variety of structuring techniques known in the art, including but not limited to, multiprogramming, multithreading, client-server, or peer-to-peer, running on one or more computer systems each having one or more processors. Some embodiments may execute concurrently and asynchronously, and communicate using message passing techniques. Equivalent synchronous embodiments are also supported. Also, other functions could be implemented or performed by each component/module, and in different orders, and by different components/modules, yet still achieve the functions of the controller 200.

In addition, programming interfaces to the data stored as part of the controller 210 can be available by standard mechanisms such as through C, C++, C #, Java, Golang, and web APIs; libraries for accessing files, databases, or other data repositories; through scripting languages such as JavaScript and VBScript; or through Web servers, FTP servers, or other types of servers providing access to stored data. The controller 210 may be implemented by using one or more database systems, file systems, or any other technique for storing such information, or any combination of the above, including implementations using distributed computing techniques.

Different configurations and locations of programs and data are contemplated for use with techniques described herein. A variety of distributed computing techniques are appropriate for implementing the components of the embodiments in a distributed manner including but not limited to TCP/IP sockets, RPC, RMI, HTTP, Web Services (XML-RPC, JAX-RPC, SOAP, and the like). Other variations are possible. Also, other functionality could be provided by each component/module, or existing functionality could be distributed amongst the components/modules in different ways, yet still achieve the functions of the system 200.

Furthermore, in some embodiments, some or all of the components/portions of the controller 210, or functionality provided by the computer-executable instructions stored on memory 201 of the system 200 may be implemented or provided in other manners, such as at least partially in firmware or hardware, including, but not limited to, one or more application-specific integrated circuits (ASICs), standard integrated circuits, controllers (e.g., by executing appropriate instructions, and including microcontrollers or embedded controllers), field-programmable gate arrays (FPGAs), complex programmable logic devices (CPLDs), and the like. Some or all of the system components or data structures may also be stored as contents (e.g., as executable or other machine-readable software instructions or structured data) on a computer-readable medium (e.g., as a hard disk; a memory; a computer network or cellular wireless network; or a portable media article to be read by an appropriate drive or via an appropriate connection, such as a DVD or flash memory device) so as to enable or configure the computer-readable medium or one or more associated computing systems or devices to execute or otherwise use or provide the contents to perform at least some of the described techniques. Such computer program products may also take other forms in other embodiments. Accordingly, embodiments of this disclosure may be practiced with other computer system configurations.

In general, a range of programming languages may be employed for implementing any of the functionality of the content presentation devices; system 200; systems, applications, and functions, of the organization; etc., present in the example embodiments, including representative implementations of various programming language paradigms and platforms, including but not limited to, object-oriented (e.g., Java, C++, C #, Visual Basic .NET, Smalltalk, and the like), functional (e.g., ML, Lisp, Scheme, and the like), procedural (e.g., C, Pascal, Ada, Modula, and the like), scripting (e.g., Perl, Ruby, PHP, Python, JavaScript, VBScript, and the like) and declarative (e.g., SQL, Prolog, and the like).

In some embodiments, aspects of the system 200 may be implemented in an application executed by a content receiver (such as the content receiver 101 described above with respect to FIG. 1), content presentation device (such as the content presentation device 107 described above with respect to FIG. 1), property management system (such as the property management system 103, described above with respect to FIG. 1), or some combination thereof. In some such embodiments, some of the functions of the system 200, such as detecting whether the user is to be temporarily associated with a content receiver, generating a temporary account for the user to use the content receiver, causing a content receiver to perform one or more actions, receiving an indication that data associated with a temporary account is to be deleted, determining a time at which data associated with the temporary account is to be deleted, or other functions of the system 200, may be performed by a computing device via execution of the application.

The operation of certain aspects will now be described with respect to FIGS. 3-5. In at least one of various embodiments, at least a portion of the processes 300, 400, and 500 described in conjunction with FIGS. 3, 4, and 5, respectively, may be implemented by one or more processors or executed via circuitry on one or more computing devices described in connection with FIG. 2, the content receivers 101 described in connection with FIG. 1, content presentation devices 107 described in connection with FIG. 1, property management system 103 described in connection in FIG. 1, other computing devices, or some combination thereof.

Furthermore, aspects of the processes 300-500 may cause a content receiver (such as the content receiver 101 described above with respect to FIG. 1), content presentation device (such as the content presentation device 107 described above with respect to FIG. 1), an MDU DVR Account Management System (such as the system 200, described above with respect to FIGS. 1 and 2), property management system (such as the property management system 103, described above with respect to FIG. 1), another computing device, or some combination thereof to take an action, such as receiving data, displaying certain data, altering the display of data, transmitting data, other actions, or some combination thereof. In some embodiments, causing a content receiver, content presentation device, the system 200, a property management system, or another device to take an action includes transmitting commands, instructions, etc., to take the action to the content receiver, content presentation device, the system 200, property management system, or other device, such as by transmitting instructions, commands, etc., from the system or device to another system or device.

FIG. 3 is a flow diagram of a process 300 for causing a content receiver to use a temporary account, according to various embodiments described herein. While any of the aspects of the process 300 may be performed by an MDU DVR Account Management System (such as the system 200, described above with respect to FIGS. 1 and 2), a content receiver (such as the content receiver 101 described above with respect to FIG. 1), content presentation device (such as the content presentation device 107 described above with respect to FIG. 1), property management system (such as the property management system 103, described above with respect to FIG. 1), another device or system, or some combination thereof, the device(s), system(s), or some combination thereof performing the process 300 will be generally referred to as “the system.”

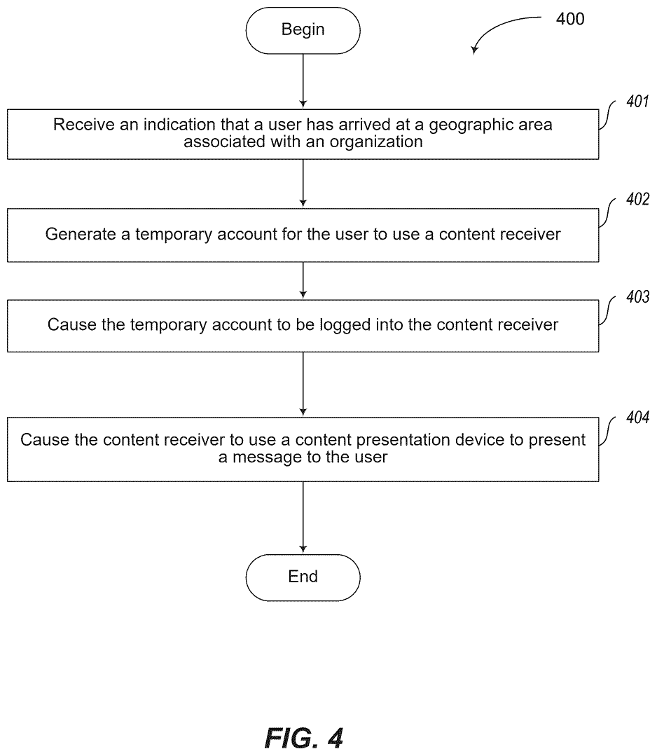

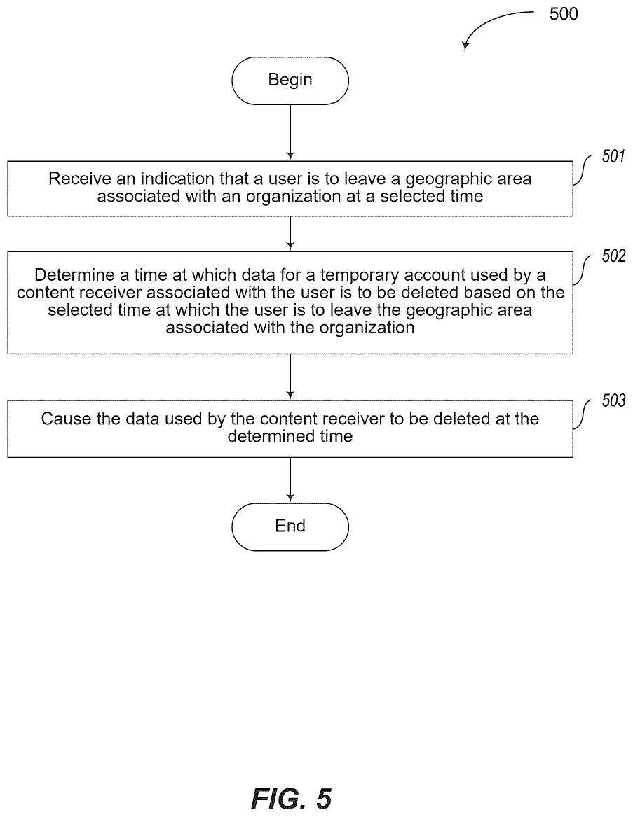

In some embodiments, as part of performing the acts included in the process 300, the system performs one or more of the acts included in the processes 400, 500, or some combination thereof, described below in connection with FIGS. 4 and 5.

The process 300 begins, after a start block, at act 301, where the system receives an indication that a user is to be temporarily associated with a content receiver. In some embodiments, the system receives the indication from a property management system, such as the property management system 103 described above in connection with FIG. 3. In some embodiments, the indication that the user is to be temporarily associated with a content receiver is received by the system based on an indication that the user is to be assigned to an area associated with an organization that has a content receiver. For example, the user may be assigned to a room in a hotel that has a content receiver that acts as a DVR device. In such an example, the assignment of the user to the room may be when the user checks into the hotel, a time earlier than the time when the user checks into the hotel, a time later than the time when the user checks into the hotel, or some combination thereof. In some embodiments, the indication that the user is to be temporarily associated with the content receiver includes information regarding the length of time that the user will be associated with the content receiver, information identifying the user, other information related to the user's association with the content receiver, other information related to the user's interaction with the organization, or some combination thereof.

The process 300 proceeds to act 302, where the system generates a temporary account for the user to use the content receiver. In some embodiments, the temporary account is assigned to the content receiver and the content receiver maintains the temporary account. In some embodiments, the temporary account is generated based on pre-selected data, data associated with the user, data associated with an area within which the content receiver is located, data associated with the content receiver, or some combination thereof. For example, if the content receiver is within a hotel room, the temporary account may be generated based on a combination of a room number of the hotel room, an identifier for the content receiver, and pre-selected data for generating temporary accounts. In some embodiments, the pre-selected data may include a pre-selected name, email address, phone number, other information, or some combination thereof. In some embodiments, as part of generating the temporary account, the system bypasses one or more account verification protocols that are applied to a non-temporary account, such as, for example, validation of email addresses or other contact information.

The process 300 proceeds to act 303, where the system causes the content receiver to use the temporary account generated at act 302. In some embodiments, the system causes the content receiver to use the temporary account by transmitting one or more instructions or commands to the content receiver. In some embodiments, the instructions or commands may be instructions or commands directing the content receiver to automatically log the temporary account in to the content receiver. In some embodiments, the instructions or commands may direct the content receiver to use the temporary account at a selected time period. For example, the instructions or commands may direct a content receiver in a hotel room to cause the temporary account to be logged into the content receiver during a selected time period that includes the time at which the user is to receive access to the hotel room, but not before the selected time period. Thus, in some embodiments, a different user or other entity with access to the hotel room before the time at which the user is to receive access to the hotel room is not able to use the temporary account generated for the user.

The process 300 proceeds to act 304, where the system receives an indication that data associated with the temporary account is to be deleted. In some embodiments, the indication that the data associated with the temporary account is to be deleted is received by the system based on an indication that the user is to no longer be assigned to an area associated with an organization that has a content receiver. For example, the indication that the data associated with the temporary account should be deleted may be received when a user checks out of a hotel room, when the user's access to the hotel room is scheduled to end, during a selected time period, after a selected amount of time has passed, other situations in which the data associated with the temporary account should be deleted, or some combination thereof. In some embodiments, the system receives the indication that data associated with the temporary account is to be deleted from a property management system. In some embodiments, the indication that data associated with the temporary account is to be deleted may be a default time period after which the data is to be deleted, such as, for example, daily, weekly, monthly, every three days, every two days, other time periods, or some combination thereof.

In some embodiments, the data associated with the temporary account comprises: recordings of one or more instances of content, instructions to record one or more instances of content, settings for the content receiver, an indication of one or more instances of content that have been viewed by the user, on-demand content licenses, movie rentals, streaming service data, information identifying the user, other information associated with the account, or some combination thereof.

The process 300 proceeds to act 305, where the system causes the content receiver to delete data associated with the temporary account. The content receiver may be caused to delete all or a portion of the data associated with the temporary account. In some embodiments, the system causes the content receiver to use the delete data associated with the temporary account by transmitting one or more instructions or commands to the content receiver. In some embodiments, the instructions or commands may be instructions or commands directing the content receiver to automatically delete the data associated with the temporary account when a condition is met, such as during a selected time period, when a user signals they are leaving the area for which the content receiver is associated, when the content receiver is unable to communicate with a property management system or MDU DVR Account Management System, other conditions for deleting data associated with the temporary account, or some combination thereof. In some embodiments, the instructions or commands may direct the content receiver to delete data associated with the temporary account at a selected time period. For example, the instructions or commands may direct a content receiver a hotel room to automatically delete the data during a time period that includes the checkout time of the user. Thus, in some embodiments, a different user or other entity with access to the hotel room after the time at which the user is to receive access to the hotel room is not able to use the temporary account generated for the user. Continuing the example, if the checkout time of the user changes, the system may transmit additional commands or instructions to the content receiver that indicate the change in checkout time, and the content receiver may automatically delete the data during a time period that includes the changed checkout time.

After act 305, the process 300 ends.

In some embodiments, when the content receiver is be unable to communicate with a property management system, the MDU DVR Account Management System, or some combination thereof, the content receiver may automatically delete data associated with a temporary account at a selected time. For example, the content receiver may be configured to delete data associated with a temporary account after a selected time period has elapsed, such as each day, each week, each two days, each three days, etc. In some embodiments, as part of performing the process 300, when the content receiver is be unable to communicate with a property management system, the MDU DVR Account Management System, or some combination thereof, the content receiver may automatically generate a new temporary account, such as in response to the deletion of a temporary account. In some embodiments, the content receiver receives one or more instructions or commands to be configured to automatically delete a temporary account after a selected period of time has elapsed, automatically generate a temporary account after a selected period of time has elapsed, automatically generate a new temporary account after data associated with a temporary account is deleted, etc. In some embodiments, the system automatically causes the deletion, generation, etc., of temporary accounts after a selected period of time when it is unable to communicate with a content receiver, a property management system, or some combination thereof.

In some embodiments, the system performs the different acts for the process 300 during different time periods. For example, the system may perform acts 301-303 during a first time period and acts 304-305 during a second time period that occurs after the first time period.

In some embodiments, instead of performing acts 302 and 303, the system authorizes a user to temporarily use the content receiver. In such embodiments, in act 305, the system may delete any data associated with the account generated by or for the user, such as scheduled recordings, recorded instances of content, user settings, etc. In some such embodiments, the temporary account may be reset to the default settings for the next user of the content receiver.

FIG. 4 is a flow diagram of a process 400 for generating a temporary account for a user based on an indication that the user has arrived at a geographic area, according to various embodiments described herein. While any of the aspects of the process 400 may be performed by an MDU DVR Account Management System (such as the system 200, described above with respect to FIGS. 1 and 2), a content receiver (such as the content receiver 101 described above with respect to FIG. 1), content presentation device (such as the content presentation device 107 described above with respect to FIG. 1), property management system (such as the property management system 103, described above with respect to FIG. 1), another device or system, or some combination thereof, the device(s), system(s), or some combination thereof performing the process 400 will be generally referred to as “the system.”

The process 400 begins, after a start block, at act 401, where the system receives an indication that a user has arrived at a geographic area associated with an organization. In some embodiments, the system receives the indication that the user arrived at the geographic area from a property management system associated with the organization. For example, the system may receive an indication that the user has checked into a hotel and received access to a hotel room. In some embodiments, the indication that the user arrived includes information related to the user, such as an identity of the user, a length of time that the user will be using services provided by the organization (for example, a length of time the user will be staying in a hotel), content receiver configuration preferences of the user, DVR user account data associated with the user, other information related to the user, or some combination thereof. In some embodiments, the geographic area may include a vehicle associated with the organization, such as an airplane, a boat, a car, a train, or another type of vehicle. In some embodiments, the geographic area may include the property of the organization.

The process 400 proceeds to act 402, where the system generates a temporary account for the user to user a content receiver. In some embodiments, the system performs act 402 in a similar manner to act 302, described above in connection with FIG. 3. In some embodiments, the system uses data included in the indication that the user has arrived at the geographic area to create the temporary account, such as the length of time the user will be using services provided by the organization, content receiver configuration preferences of the user, the identity of the user, etc.

The process 400 proceeds to act 403, where the system cause the temporary account to be logged into the content receiver. In some embodiments, the system performs act 403 in a similar manner to act 303, described above in connection with FIG. 3. In some embodiments, where the indication that the user has arrived at the geographic area includes one or more preferences of the user, the system may configure the content receiver based on the one or more preferences. For example, the system may automatically configure the content receiver to initially use a selected volume range, to prioritize displaying a user's “favorite” channels over other channels, record types of content that the user has recorded in the past, configure the content receiver in other ways based on one or more preferences of the user, or some combination thereof.

The process 400 proceeds to act 404, where the system causes the content receiver to use a content presentation device to present a message to the user. In some embodiments, the system, content receiver, property management system, or some combination thereof generate the message based on the indication that the user has arrived at a geographic area associated with the organization. In some embodiments, the message is a welcome message generated based on an indication that the user has arrived at the geographic area associated with the organization. For example, if the user has checked into a hotel, the message may be a message that welcomes the user to the hotel and may include the name of the user.

After act 404, the process 400 ends.

FIG. 5 is a flow diagram of a process 500 to delete data used by a content receiver at a determined time, according to various embodiments described herein. While any of the aspects of the process 500 may be performed by an MDU DVR Account Management System (such as the system 200, described above with respect to FIGS. 1 and 2), a content receiver (such as the content receiver 101 described above with respect to FIG. 1), content presentation device (such as the content presentation device 107 described above with respect to FIG. 1), property management system (such as the property management system 103, described above with respect to FIG. 1), another device or system, or some combination thereof, the device(s), system(s), or some combination thereof performing the process 500 will be generally referred to as “the system.”

The process 500 begins, after a start block, at act 501, where the system receives an indication that a user is to leave a geographic area associated with an organization at a selected time. The system may receive the indication that the user is to leave the geographic area in a similar manner to receiving an indication that the user has arrived at the geographic area, such as the manner described in act 301 of FIG. 3. For example, the user may have a scheduled checkout time that is determined when the user checks into a hotel.

The process 500 proceeds to act 502, where the system determines a time at which data for a temporary account used by a content receiver associated with the user is to be deleted based on the selected time at which the user is to leave the geographic area associated with the organization. In some embodiments, the determined time is the time at which the user is to leave the geographic area. In an example embodiment, the time at which the data is to be deleted is determined based on a checkout time of the user. In some embodiments, the determined time is a period of time. In some such embodiments, the system may cause the content receiver to delete the data at any time during the period of time. In some embodiments, the system may determine when to delete the data during the period of time based on a determination of whether the content receiver is currently in use by the user. For example, if the system has determined that the data is to be deleted between 9:00 am and 10:00 am, and the content receiver is in use at 9:00 am, the system may wait up until 10:00 am to cause the data to be deleted. In a similar example, if the time period to delete the data is between 9:00 am and 10:00 am and the system detects that the content receiver is no longer in use at 9:30 am, the system may cause the data to be deleted at 9:30 am.

The process proceeds to act 503, where the system causes the data used by the content receiver to be deleted at the determined time. In some embodiments, the system performs act 503 in a similar manner to act 305, described above in connection with FIG. 3.

After act 503, the process 500 ends.

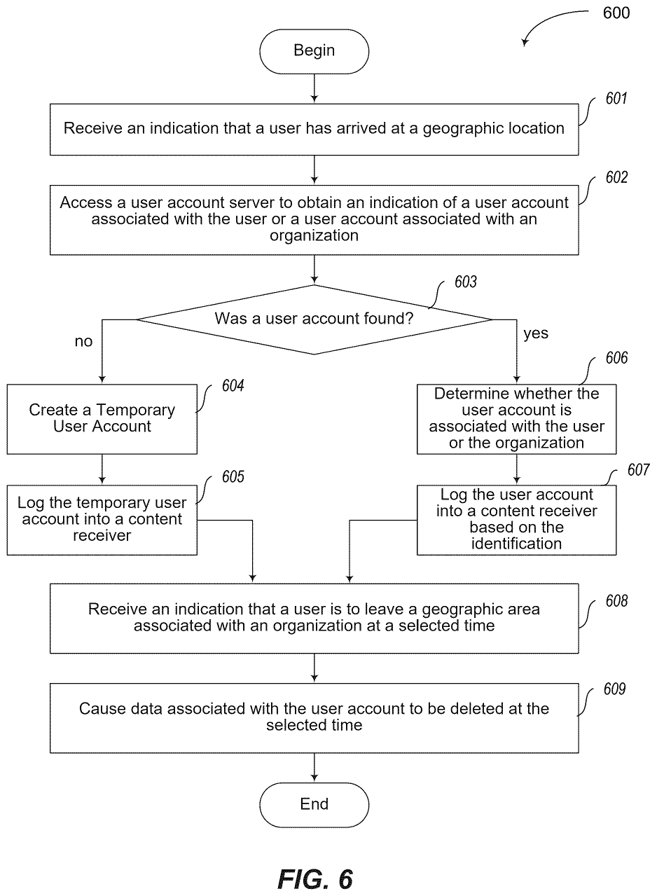

FIG. 6 is a flow diagram of a process 600 to automatically configure a content receiver for a user, according to various embodiments described herein. While any of the aspects of the process 500 may be performed by an MDU DVR Account Management System (such as the system 200, described above with respect to FIGS. 1 and 2), a content receiver (such as the content receiver 101 described above with respect to FIG. 1), content presentation device (such as the content presentation device 107 described above with respect to FIG. 1), property management system (such as the property management system 103, described above with respect to FIG. 1), another device or system, or some combination thereof, the device(s), system(s), or some combination thereof performing the process 600 will be generally referred to as “the system.”

The process 600 begins, after a start block, at act 601, where the system receives an indication that a user has arrived at a geographic location. The system may perform act 601 in a similar manner to act 401, described above in connection with FIG. 4.

The process 600 proceeds to act 602, where the system accesses a user account server, such as the user account server 109 described above in connection with FIG. 1, to obtain an indication of a user account associated with the user or a user account associated with an organization.

The process 600 proceeds to act 603, where the system determines whether a user account was found by the user account server at act 602. If the user account was not found, the process proceeds to act 604, otherwise, the process proceeds to act 606.

At act 604, the system creates a temporary user account. The system may perform act 604 in a similar manner to act 302, described above in connection with FIG. 3.

The process 600 proceeds to act 605, where the system logs the temporary user account into a content receiver. The system may perform act 605 in a similar manner to act 303, described above in connection with FIG. 3.

At act 606, the system determines whether the user account is associated with the user or with the organization. In some embodiments, a user account associated with a user may be a user account that the user uses to log into their own devices, such as a content receiver or mobile device that is associated with the user. For example, the user account may be an account that is logged into a content receiver present in the home of the user. In some embodiments, a user account associated with an organization may be a user account that was generated for the user when the user was located within a geographic area associated with the organization, a user account that the organization generates for the use of one or more users, etc. In such embodiments, the user may be given the option by the organization to save data associated with a user account that was associated with the user via one of or more of the computer systems, devices, servers, etc., described above in connection with FIG. 1; one or more other computer systems, devices, servers, etc., such as via a profile of the user associated with the organization; or some combination thereof. For example, the user may indicate to a hotel that a user account generated for the user's stay at the hotel is to be saved, so that the user will be logged into the account when the user stays at the hotel, or another hotel associated with the hotel, again.

After act 606, the process 600 proceeds to act 607, where the system logs the user account into a content receiver based on the identification. The system may perform act 607 in a similar manner to act 303, act 403, or some combination thereof, described above in connection with FIGS. 3 and 4 respectively. In some embodiments, as part of performing act 607, the system causes the content receiver to be configured based on data associated with the identified user account.

After act 607 or act 605, the process 600 proceeds to act 608, where the system receives an indication that a user is to leave a geographic area associated with an organization at a selected time. The system may perform act 608 in a similar manner to act 501, described above in connection with FIG. 5.

Ther process 600 proceeds to act 609, where the system causes data associated with the user account to be deleted at the selected time. In some embodiments, the system performs act 609 in a similar manner to act 503, described above in connection with FIG. 5.

After act 609, the process 600 ends.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system comprising:
at least one processor; and
at least one non-transitory processor-readable storage medium storing instructions or data thereon, the instructions or data, when executed by the at least one processor, cause the at least one processor to:
at a first time:
receive an indication that a user is to be temporarily associated with a content receiver;
generate a temporary account for the user to use the content receiver based on the indication of the user; and
cause the content receiver to use the temporary account; and
at a second time that occurs after the first time:
receive an indication that data associated with the temporary account is to be cleared at a first selected time;
determine whether the content receiver is in use at the first selected time;
based on a determination that the content receiver is in use at the first selected time:
identify a second selected time at which the content receiver is to clear the data associated with the temporary account; and
cause the content receiver to clear the data associated with the temporary account at the second time; and
based on a determination that the content receiver is not in use at the first selected time, cause the content receiver to clear the data associated with the temporary account.

2. The system of claim 1, wherein, to receive the indication that data associated with the temporary account is to be cleared, the instructions or data further cause the at least one processor to:
receive an indication of a time at which the user is to depart from a geographic location associated with an organization associated with the content receiver; and
cause the content receiver to clear the data associated with the temporary account based on the time at which the user is to depart from the geographic location.

3. The system of claim 1, wherein, to receive the indication that the user is to be temporarily associated with the content receiver, the instructions or data further cause the at least one processor to:
receive an indication of a time at which the user is to arrive at a geographic location associated with an organization associated with the content receiver.

4. The system of claim 3, wherein, to receive the indication of the time at which the user is to be temporarily associated with the content receiver includes information identifying the user and the instructions or data further cause the at least one processor to:
cause the content receiver to use a content presentation device to display the information identifying the user.

5. The system of claim 1, wherein the instructions or data further cause the at least one processor to:
receive the indication that data associated with the temporary account is to be cleared after a pre-selected amount of time has passed.

6. The system of claim 1, wherein, to cause the content receiver to use the temporary account, the instructions or data further cause the at least one processor to:
transmit one or more commands to the content receiver to use the temporary account.

7. The system of claim 1, wherein, to cause the content receiver to clear the data associated with the temporary account, the instructions or data further cause the at least one processor to:
transmit one or more commands to the content receiver to clear the data associated with the temporary account.

8. The system of claim 1, wherein:
the content receiver is a device associated with a hotel room; and
the temporary account is associated with the hotel room.

9. The system of claim 1, wherein the content receiver is associated with a property management system and the instructions or data further cause the at least one processor to:
detect that the content receiver is unable to communicate with the property management system during a pre-selected period of time; and
cause the content receiver to clear the data associated with the temporary account based on the detection that the content receiver is unable to communicate with the property management system during the pre-selected period of time.

10. The system of claim 1, wherein the indication that data associated with the temporary account is to be cleared comprises an indication that at least one of: DVR data, on demand content data, movie rental data, or streaming service data, is to be cleared.

11. A non-transitory processor-readable storage medium that stores at least one of instructions or data, the instructions or data, when executed by at least one processor, cause the at least one processor to perform a method comprising:
at a first time:
receiving an indication that a user is to be temporarily associated with a content receiver;
generating a temporary account for the user to use the content receiver based on the indication of the user; and
causing the content receiver to use the temporary account; and
at a second time that occurs after the first time:
receiving an indication that data associated with the temporary account is to be cleared; at a first selected time;
determine whether the content receiver is in use at the first selected time;
based on a determination that the content receiver is in use at the first selected time:
identify a second selected time at which the content receiver is to clear the data associated with the temporary account; and
cause the content receiver to clear the data associated with the temporary account at the second time; and
based on a determination that the content receiver is not in use at the first selected time, causing the content receiver to clear the data associated with the temporary account.

12. The non-transitory processor-readable storage medium of claim 11, wherein receiving the indication that data associated with the temporary account is to be cleared further comprises:
receiving an indication of a time at which the user is to depart from a geographic location associated with an organization associated with the content receiver; and
causing the content receiver to clear the data associated with the temporary account based on the time at which the user is to depart from the geographic location.

13. The non-transitory processor-readable storage medium of claim 11, wherein the method further comprises, at the first time:
causing the content receiver to use a content presentation device to display the information identifying the user at a selected time.

14. The non-transitory processor-readable storage medium of claim 11, wherein the method further comprises:
receiving the indication that data associated with the temporary account is to be cleared after a selected period of time.

15. The non-transitory processor-readable storage medium of claim 11, wherein the method further comprises:
detecting that the content receiver is unable to communicate with a property management system during a selected time period; and
causing the content receiver to clear the data associated with the temporary account based on the detection that the content receiver is unable to communicate with the property management system during the selected time period.

16. A non-transitory processor-readable storage medium that stores at least one of instructions or data, the instructions or data, when executed by at least one processor, cause the at least one processor to perform a method comprising:
at a first time:
receiving an indication that a user is to be temporarily associated with a content receiver;
generating a temporary account for the user to use the content receiver based on the indication of the user; and
causing the content receiver to use the temporary account; and
at a second time that occurs after the first time:
receiving an indication that data associated with the temporary account is to be cleared; at a first selected time;
determine whether the content receiver is in use at the first selected time;
based on a determination that the content receiver is in use at the first selected time:
identify a second selected time at which the content receiver is to clear the data associated with the temporary account; and
cause the content receiver to clear the data associated with the temporary account at the second time; and
based on a determination that the content receiver is not in use at the first selected time, causing the content receiver to clear the data associated with the temporary account.

17. The non-transitory processor-readable storage medium of claim 16, wherein receiving the indication that data associated with the temporary account is to be cleared further comprises:
receiving an indication of a time at which the user is to depart from a geographic location associated with an organization associated with the content receiver; and
causing the content receiver to clear the data associated with the temporary account based on the time at which the user is to depart from the geographic location.

18. The non-transitory processor-readable storage medium of claim 16, wherein the method further comprises, at the first time:
causing the content receiver to use a content presentation device to display the information identifying the user at a selected time.

19. The non-transitory processor-readable storage medium of claim 16, wherein the method further comprises:
receiving the indication that data associated with the temporary account is to be cleared after a selected period of time.

20. The non-transitory processor-readable storage medium of claim 16, wherein the method further comprises:
detecting that the content receiver is unable to communicate with a property management system during a selected time period; and
causing the content receiver to clear the data associated with the temporary account based on the detection that the content receiver is unable to communicate with the property management system during the selected time period.
